(19) United States
(12) Patent Application Publication
(10) Pub. No.: US 2004/0215790 A1
(43) Pub. Date: Oct. 28, 2004

(54) Information network access

(76) Inventor: Robert A. Miller, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/422,593

(22) Filed: Apr. 24, 2003

(51) Int. Cl. G06F 15/16; G06F 12/14

(52) U.S. Cl. 709/229; 713/201; 707/9

(57) ABSTRACT

A system and method provide access to information in an information network that is coupled to information from multiple varied services. The multiple information services are contacted and provided authentication information. Data, control and presentation instructions are received from the information services and displayed to a user in accordance with the presentation instructions to provide a consistent user interface to the multiple information services.

### FIELD OF THE INVENTION

The present invention relates to information and in particular to accessing information on a network.

### BACKGROUND OF THE INVENTION

Accessing information from multiple information sources coupled to a network may require the use of different tools for each source. Currently, an ID and password is normally required for each such source, and the interface and mechanisms for viewing the data can be quite different. For instance, many banks provide internet access to user account information, but the interface and methods of interacting with different banks varies greatly. Further interfaces and methods may be required for brokerage or retirement account information. Still further, intranets of different companies may utilize still further different interfaces for retrieving information and for interaction with the information source. Even personal data is accessible via network, and may utilize still further different interfaces and method of interaction.

### BRIEF DESCRIPTION OF THE DRAWINGS

The following drawings are various representations of embodiments of the invention. Other embodiments are within the scope of the claims herein.

FIG. 1 is a block diagram of an example embodiment of a system for accessing information via a network.

FIG. 2 is a flowchart of an example embodiment of a method for accessing information via a network.

FIG. 3 is an XML of an example embodiment of a data document.

FIGS. 4A and 4B arc an XML of an example embodiment of a control document.

FIGS. 5A, 5B and 5Ca arc an XML of an example embodiment of a presentation ticket.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions may correspond to modules, which are software, hardware, firmware of any combination thereof. Multiple functions may be performed in one or more modules as desired, and the embodiments described are merely examples.

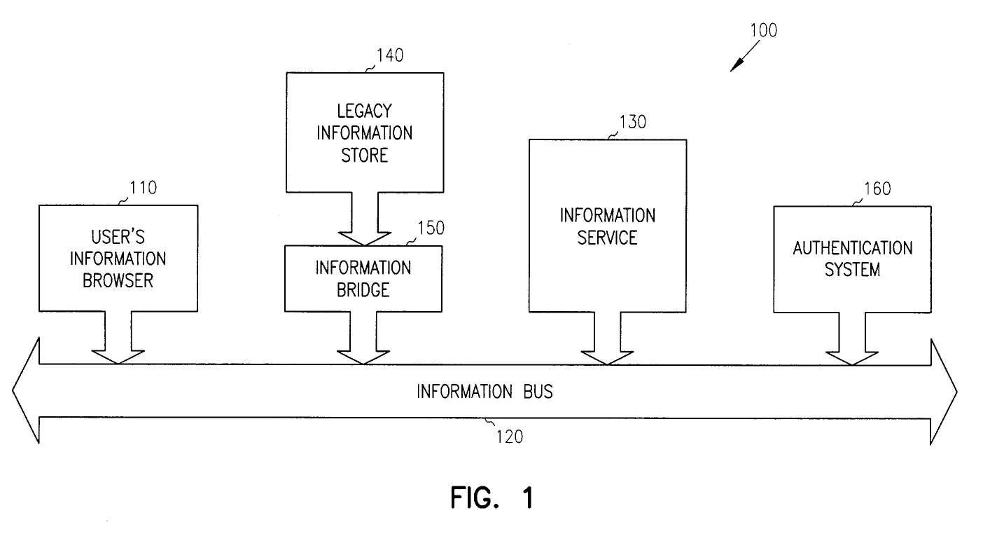

A system for accessing information is shown generally at 100 in FIG. 1. The system 100 utilizes a user information browser 110, such as an internet based world wide web browser. The browser 110 is coupled to a network, such as the internet as represented by information bus 120. Information bus 120 is also representative of a logical network of multiple information sources, such as sources that span the Internet and corporate or other intranets. Some information sources, include an information service 130 coupled to information bus 120, and a legacy information store 140 coupled through an information bridge 150 to information bus 120. A legacy information store may be an institution that the user has a relationship with, such as a bank, brokerage, retirement account, pharmacy, medical clinic, or other entity.

In one embodiment, an authentication system 160 is used to provide authentication credentials for the multiple information services. It may be thought of as providing a global identity. This alleviates a user from having to individually sign in to different information sources. Different kinds of authentication services may be utilized, such as one requiring each information source to register, or one where the authentication may be distributed, only requiring supply of credentials from users for each information source. Such credentials are then used directly with each information source, and no formal relation ship need be established. This distributed authentication is loosely referred to as a federated identity authentication.

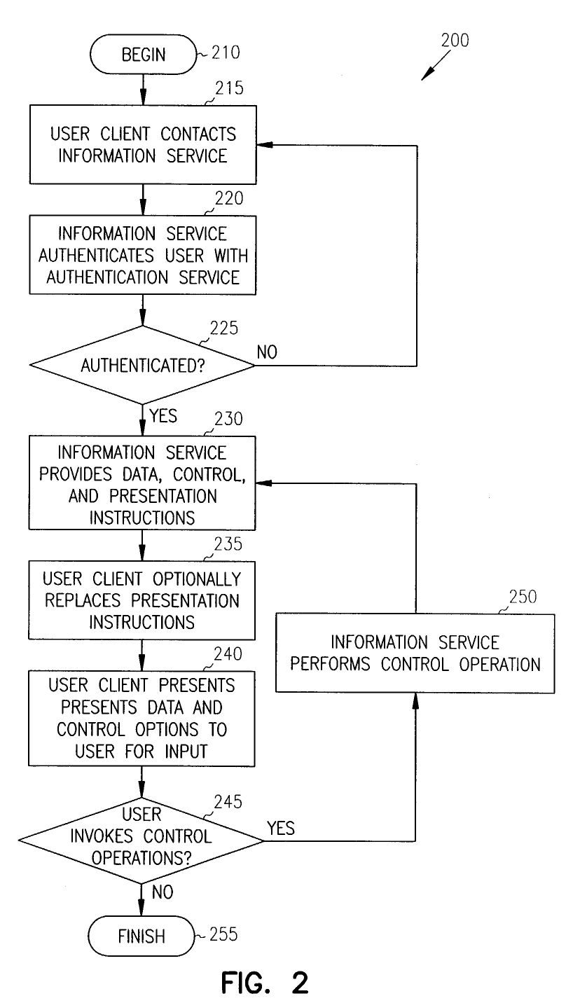

FIG. 2 provides a flowchart showing user interaction with the system generally at 200. The user begins at 210, obtaining access to the network. At 215, the user selects a desired information service, and a user client contacts the information service. At 220, the user is authenticated with the authentication service. If not authenticated as indicated at 225, the user may try again at 215, either reinitiating contact with the same information service, or selecting a different information service.

If the user is authenticated at 225, the information service provides data, control and presentation instructions at 230. The user client optionally replaces presentation instructions at 235, and presents data and control options to the user for input at 240. If at 245, the user invokes control operations, the information service performs the control operations at 250. Processing then continues again at 230, wherein the information service provides data, control and presentation instructions, this time with the user invoked control operations. The user may again be given the option to replace presentation instructions at 235, or invoke further control operations at 235. If no such control operations are invoked, the process finishes at 255.

A set of generic capabilities and intents is defined, and used to interact with the various information sources. In one embodiment, an information source is asked to describe its capabilities. Such capabilities are then selected and submitted back as an intent. The intent may be an intent to sell or buy, or obtain a balance, or query other information. The display of the capabilities and information received at the browser is displayed under control of the system, not necessarily under control of the information source. In one embodiment, extended mark up language is used to obtain the flexibility of display of the information.

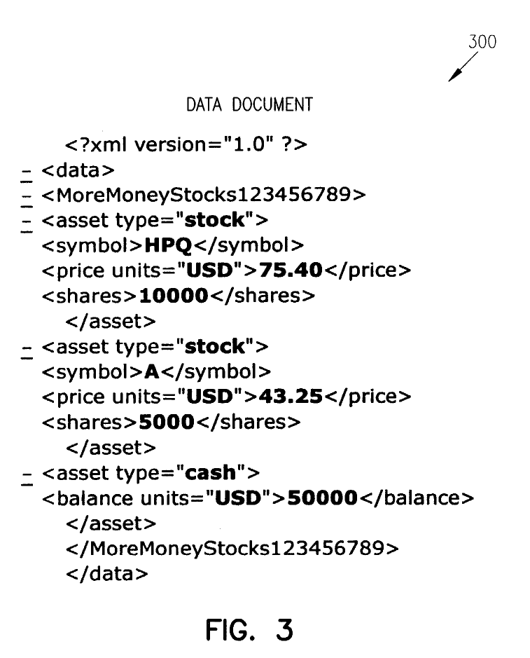

One example of a data document 300 used to exchange information between the services is shown in FIG. 3. This example is written in XML, a tag based language. As seen in FIG. 3, an example of a data document for interchanging data with a financial institution is shown. Stocks and cash are described for an account referred to as <MoreMoneyStocks123456789>. Asset types are identified by an asset type statement. In this example, two stocks are identified having symbols HPQ and A, a current price and price units are defined for each stock as well as a number of shares. In addition, a cash balance of 50000 is also identified in the account. Such a cash balance may also have a price per share and number of shares. Each information service uses the data document to retrieve information to be communicated to a user. In one embodiment, the information bridge 150 is used to interface with the information service in it's own data exchange protocol. The information bridge 150 then populates the data document 300.

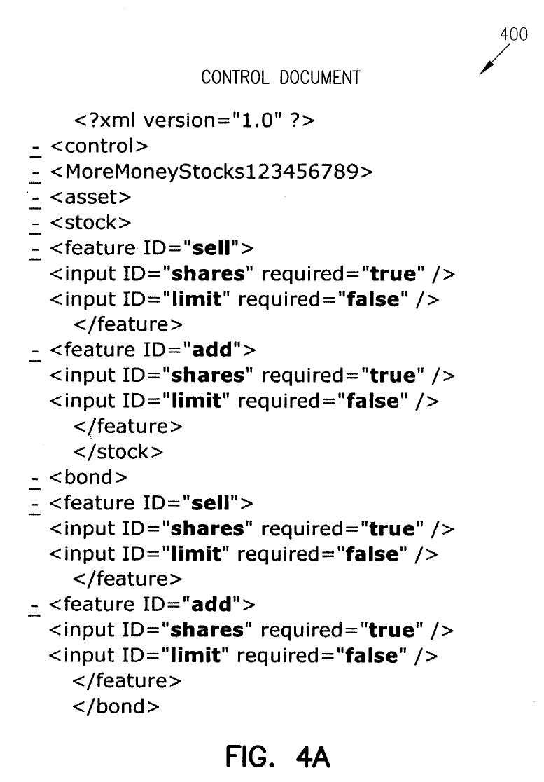

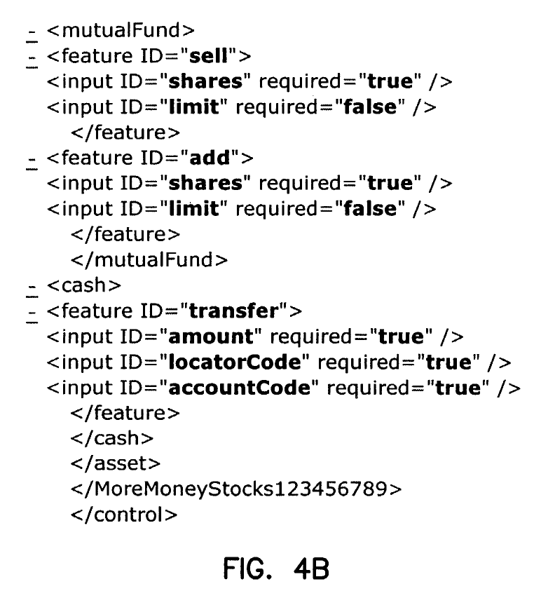

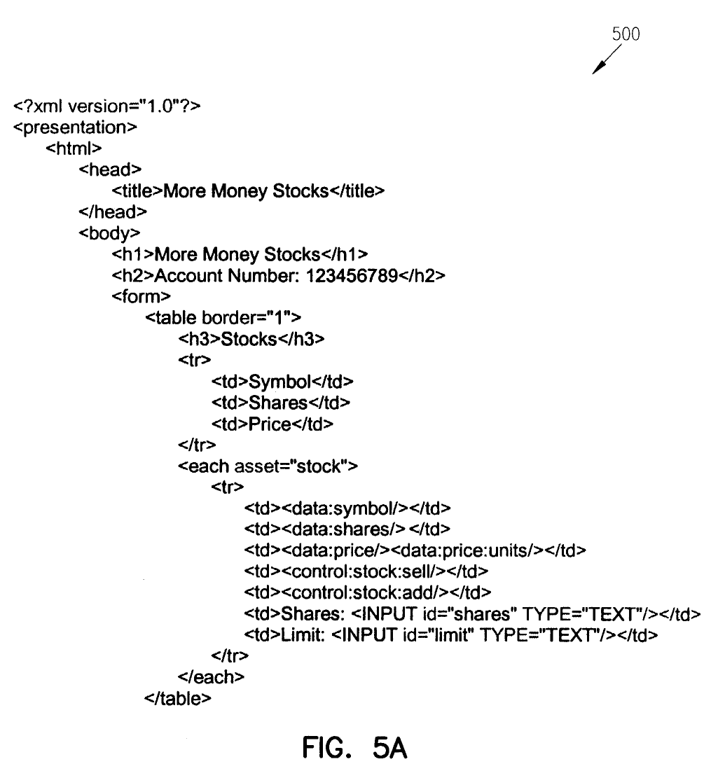

A control document 400 is shown in FIGS. 4A and 4B. In a similar manner, the control document 400 is an example written in XML that describes certain functions for interaction with all information services. Control document 400 provides a communication mechanism for control functions related to a financial institution. In this example, features such as selling and adding or purchasing stocks, bonds and mutual funds is provided. Some of the identifying parameters referred to as input IDs include the number of shares and a limit. The control document 400 also includes functions associated with a cash account, such as transfer, amount and account codes. The information service receiving a control document 400 performs the control functions specified in the control document 400.

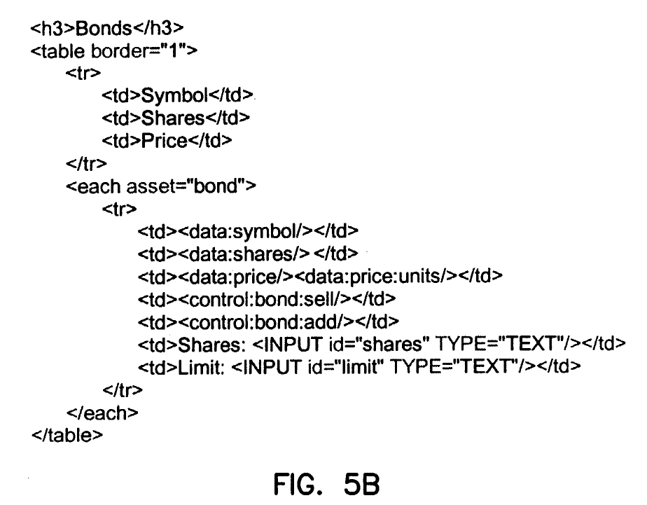

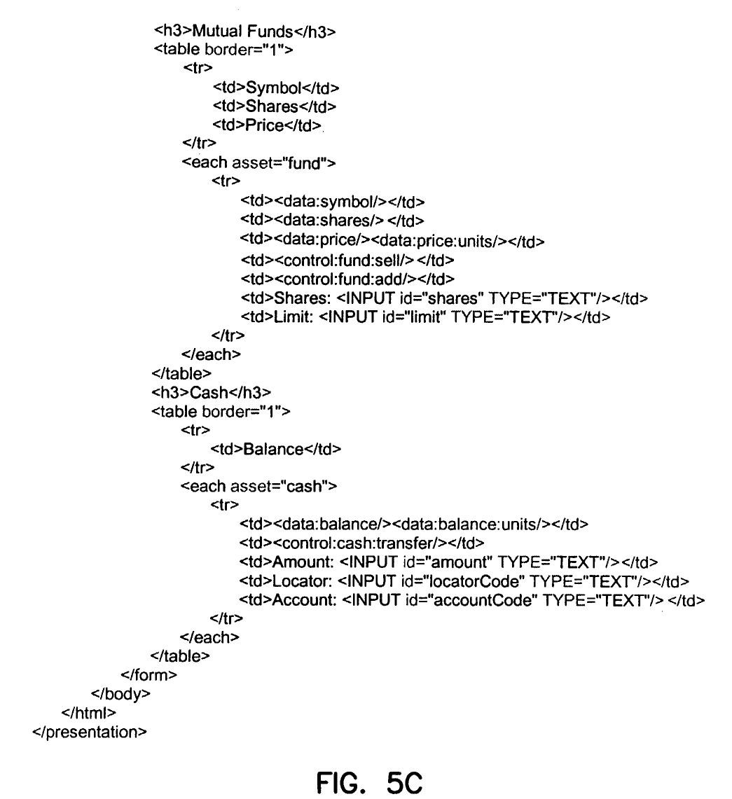

FIGS. 5A, 5B and 5C illustrate an example of a presentation ticket 500 or document at 510. It is also written in XML. The presentation ticket receives information from both the data document 310 and the control document 410, and formats the data for consistent display. In one embodiment, the presentation document directly references the control and data documents. In this particular example, a report is created showing the title of the account, and current shares or balances along with features and parameters specified for each. Current shares, as well as options for selling or adding stocks is provided. Thus, the code formats the information from multiple different financial services in the same manner, providing a consistent interface for the user.

### Conclusion

A system comprises a set of services and interfaces that is layered on top of a network infrastructure to create an information bus. Linked to this information bus is a set of required services—identity, document transformation, etc, and bridges to existing user data stores. These data stores may include user personal data, user business data, or other business data that the user is permitted to access. Data from services such as user bank and investment accounts are examples. The system may be used to provide context specific protection as opposed to existing first generation firewall technology that manages connections. Further, the system may allow access of all relevant user information with a single user tool.

1. A method of accessing information from an information network providing access to information from multiple varied services, the method comprising:
contacting multiple information services coupled to the information network;
providing authentication information to the information services;
receiving data, control and presentation instructions from the information services; and
displaying information from the information services in accordance with the presentation instructions to provide a consistent user interface to the multiple information services.

2. The method of claim 1 wherein the presentation instructions are modified prior to display.

3. The method of claim 1 wherein the presentation instructions utilize information from the data and control instructions.

4. The method of claim 3 wherein the data and control instructions are in the form of XML documents.

5. The method of claim 3 wherein the control instructions provide feature selection information for display by the presentation instructions.

6. The method of claim 1 wherein the information services are selected from different financial institutions having different information access protocols.

7. The method of claim 6 wherein the data and control instructions provide for consistent data exchange between the information services and the information browser.

8. A method of accessing information from an information network, the method comprising:
contacting an information service coupled to the information network;
providing authentication information to the information service;
receiving data, control and presentation instructions from the information service;
receiving user invoked control operations; and
transferring the user invoked control operations to the information service.

9. The method of claim 8 wherein the data, control and presentation instructions are in the form of a tag based document.

10. The method of claim 8 wherein the information network comprises the Internet.

11. The method of claim 8 wherein multiple information services are contacted.

12. The method of claim 11 wherein the presentation instructions are consistent regardless of the information service contacted.

13. The method of claim 8 wherein the authentication information facilitates a federated identity authentication.

14. A system for accessing data comprising:
an information bus;
an information browser coupled to the information bus;
an authentication system coupled to the information bus;
an information bridge coupled to the information bus; and
a legacy information store coupled to the information bridge, wherein the information bridge interfaces with the legacy information system to provide a consistent interface for display on the information browser.

15. The system of claim 14 and further comprising data and control documents that provide for consistent data exchange between the legacy information store and information browser.

16. A system for accessing information from an information network coupled to multiple varied information services, the system comprising:
means for contacting multiple information services coupled to the information network;
means for providing authentication information to the information services;
means for receiving data, control and presentation instructions from the information services; and
means for displaying information from the information services in accordance with the presentation instructions to provide a consistent user interface to the multiple information services.

17. A machine readable medium having a set of data structures for facilitating access to information across multiple different information services, the structures comprising:
a data document that identifies types of data and values for the data;
a control document that identifies features associated with the data of the data document; and
a presentation ticket that utilizes information from the data document and the control document to provide a consistent user interface for the different information services.

18. The machine readable medium having a set of data structures of claim 17 wherein the data document, control document and presentation ticket are written in a tag based language.

19. The machine readable medium having a set of data structures of claim 17 wherein the tag based language is XML.

20. The machine readable medium of claim 17 wherein the control document identifies features associated with a financial institution information service.
